(19) United States
(12) Patent Application Publication
(10) Pub. No.: US 2015/0195457 A1
(43) Pub. Date: Jul. 9, 2015

(54) APPARATUS AND METHOD FOR IMAGE CORRECTION

(71) Applicant: SAMSUNG ELECTRO-MECHANICS CO., LTD., Suwon-Si (KR)

(72) Inventors: Sang Jin KIM, Suwon-Si (KR); Hee Yong YOO, Suwon-Si (KR)

(73) Assignee: SAMSUNG ELECTRO-MECHANICS CO., LTD., Suwon-Si (KR)

(21) Appl. No.: 14/218,358

(22) Filed: Mar. 18, 2014

(30) Foreign Application Priority Data
Jan. 3, 2014 (KR) 10-2014-0000753

(51) Int. Cl. H04N 5/232; H04N 5/262

(52) U.S. Cl. CPC H04N 5/23267; H04N 5/23258; H04N 5/23287; H04N 5/2628; H04N 2101/00

(57) ABSTRACT

An apparatus for image correction may include a first sensor sensing movement of a camera module, a lens control unit adjusting a position of a lens in the camera module in accordance with the movement of the camera module sensed by the first sensor; a second sensor sensing the position of the lens, an error vector calculation unit calculating an error vector based on the movement of the camera module sensed by the first sensor and the position of the lens sensed by the second sensor, and a correction unit correcting an image from the camera module based on the error vector.

### CROSS-REFERENCE TO RELATED APPLICATION

This application claims the benefit of Korean Patent Application No. 10-2014-0000753, filed on Jan. 3, 2014, with the Korean Intellectual Property Office, the disclosure of which is incorporated herein by reference.

### BACKGROUND

The present disclosure relates to an apparatus and a method for image correction.

Recently, as camera modules in digital imaging apparatuses, such as digital cameras or smartphones, are being reduced in size, camera shake becomes an issue. Camera shake refers to motion blur appearing in an image captured by a camera due to motion of the camera such as movement and rotation during exposure.

To overcome this, existing digital imaging apparatuses employ optical image stabilization (OIS) technology that corrects shake by adjusting the position of a lens by the amount of shaking, or digital image stabilization (DIS), that performs post-correction on a captured image using a motion point spread function.

In the OSI scheme, however, an error between the amount of shaking measured by a gyro sensor and the actual movement amount of a lens may occur, such that motion blur corresponding to the error remains.

Further, as for the DIS scheme, although the low manufacturing costs associated therewith are advantageous, it has poor performance in removing motion blur, as compared to the OIS scheme.

### SUMMARY

An exemplary embodiment in the present disclosure may provide an apparatus and a method for image correction in which an error vector is calculated based on movement of a camera sensed by a first sensor and a position of a lens sensed by a second sensor, and an image is corrected based thereon, so that a clearer image may be obtained.

According to an exemplary embodiment in the present disclosure, an apparatus for image correction may include: a first sensor sensing movement of a camera module; a lens control unit adjusting a position of a lens in the camera module in accordance with the movement of the camera module sensed by the first sensor; a second sensor sensing the position of the lens; an error vector calculation unit calculating an error vector based on the movement of the camera module sensed by the first sensor and the position of the lens sensed by the second sensor; and a correction unit correcting an image from the camera module based on the error vector.

The lens control unit may adjust the position of the lens in a direction opposite to that of the movement of the camera module sensed by the first sensor.

The first sensor may sense angular velocity of the camera module, and the lens control unit may calculate a motion vector of the lens corresponding to the angular velocity of the camera module sensed by the first sensor and may adjust the position of the lens according to the calculated motion vector of the lens.

The error vector calculation unit may compare a value of angular velocity sensed by the first sensor with a value of a position of the lens sensed by the second sensor so as to calculate an error vector.

The motion vector may be calculated by integrating values of angular velocity sensed by the first sensor.

The lens control unit may include: a motion vector calculation unit calculating a motion vector of the lens corresponding to the movement of the camera module sensed by the first sensor; and a lens driving unit adjusting the position of the lens based on the calculated motion vector of the lens.

The motion vector calculation unit may be a PID controller receiving a feedback signal indicating the position of the lens from the second sensor to calculate the motion vector.

The error vector calculation unit may only be operated while a shutter of the camera module is open.

The first sensor may be a gyro sensor detecting angular velocity of the camera module.

The second sensor may be a hall sensor detecting the position of the lens.

According to an exemplary embodiment in the present disclosure, an apparatus for image correction may include: a gyro sensor sensing angular velocity of a camera module; a lens control unit calculating a motion vector corresponding to the sensed angular velocity and adjusting a position of a lens of the camera module based on the motion vector; a hall sensor sensing the position of the lens; an error vector calculation unit comparing a value of angular velocity of the camera module sensed by the gyro sensor with a value of the position of the lens sensed by the hall sensor so as to calculate an error vector; and a correction unit correcting an image captured by the lens based on the error vector, wherein the lens control unit and the error vector calculation unit are only operated while a shutter of the camera module is open.

The lens control unit may calculate a motion vector of the lens corresponding to angular velocity of a camera module sensed by the gyro sensor and adjust the position of the lens based on the calculated motion vector of the lens.

The motion vector may be calculated by integrating values of angular velocity sensed by the gyro sensor.

The lens control unit may include: a motion vector calculation unit calculating a motion vector of the lens corresponding to angular velocity of the camera module sensed by the gyro sensor; and a lens driving unit adjusting the position of the lens based on the calculated motion vector of the lens.

The motion vector calculation unit may be a PID controller receiving a feedback signal indicating the position of the lens from the hall sensor to calculate the motion vector.

According to an exemplary embodiment in the present disclosure, a method for image correction includes: a) sensing movement of a camera module; b) adjusting a position of a lens in the camera module in accordance with the sensed movement of the camera module; c) sensing the position of the lens; d) calculating an error vector based on the sensed movement of the camera module and the sensed position of the lens; and e) correcting an image from the camera module based on the error vector.

The operation a) of adjusting of the position of the lens may include calculating a motion vector of the lens corresponding to the sensed movement of the camera module; and adjusting the position of the lens based on the calculated motion vector of the lens.

The operations a) to d) may be repeatedly performed a predetermined number of times depending on the time period in which the shutter of the camera module is open.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of an apparatus for image correction according to an exemplary embodiment of the present disclosure;

FIG. 2 is a block diagram of the lens control unit shown in FIG. 1 according to an exemplary embodiment of the present disclosure;

FIG. 3 is block diagram of the lens control unit shown in FIG. 1 according to another exemplary embodiment of the present disclosure;

FIG. 4 is a flowchart for illustrating a method for image correction according to an exemplary embodiment of the present disclosure; and

FIG. 5 is a flowchart for illustrating adjusting of the position of a lens of the method illustrated in FIG. 4 according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

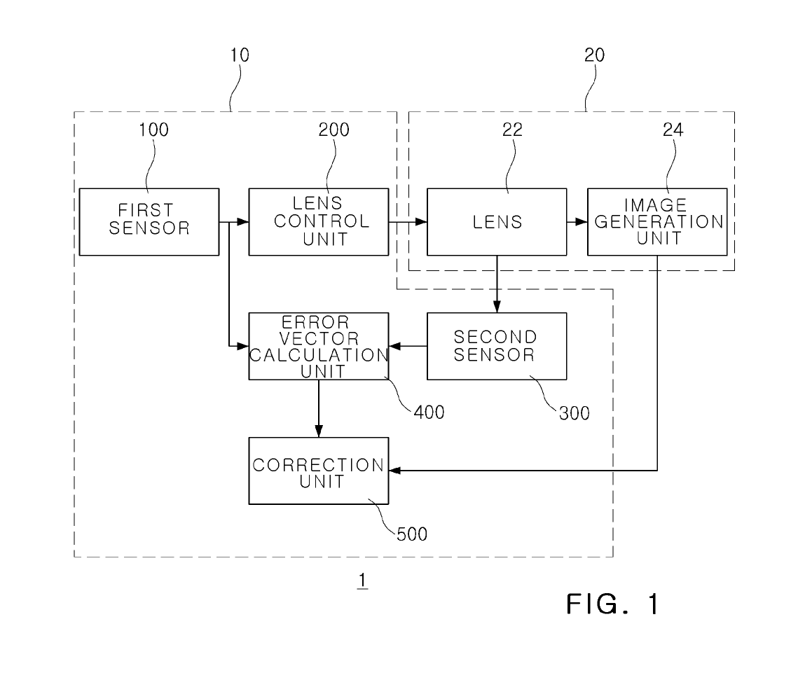

FIG. 1 is a block diagram of an apparatus for image correction according to an exemplary embodiment of the present disclosure.

Referring to FIG. 1, the apparatus 10 for image correction according to the exemplary embodiment of the present disclosure may include a first sensor 100, a lens control unit 200, a second sensor 300, an error vector calculation unit 400, and a correction unit 500.

The apparatus 10 for image correction may be installed in a digital imaging device 1 (such as a digital camera or a smartphone) along with a camera module and may serve to correct an image captured by the camera module 20. The camera module 20 may include a lens 22 through which light passes and an image generation unit 24 that receives the light so as to generate an image signal.

Specifically, the apparatus 10 for image correction may sense shaking of the camera module 20 and may move the lens 22 in the camera module 20 in response to the shaking so as to prevent motion blur caused by the shaking. Further, the apparatus 10 for image correction may compare sensed amount of shaking with the position of the lens 22 according thereto to calculate an error vector and may correct the image captured by the camera module 20 based on the error vector.

The first sensor 100 may sense the movement of the camera module 20. In an exemplary embodiment, the first sensor 100 may be a gyro sensor that measures angular velocity of the camera module 20. The value of the angular velocity may include a pitch value or a yaw value. That is, the first sensor 100 may measure a pitch value and a yaw value of the camera module 20 and may output the measured values to the lens control unit 200.

The lens control unit 200 may adjust the position of the lens 22 in accordance with the movement of the camera module 20 sensed by the first sensor 100. In an exemplary embodiment, the lens control unit 200 may adjust the position of the lens 22 in a direction opposite to that of the movement of the camera module 20.

Specifically, the lens control unit 200 may calculate a motion vector corresponding to angular velocity of the camera module 20 sensed by the first sensor 100 and may adjust the position of the lens 22 in accordance with the calculated motion vector. The motion vector may be calculated by integrating values of the angular velocity. The lens control unit 200 may only be operated while a shutter (not shown) of the camera module 20 is open.

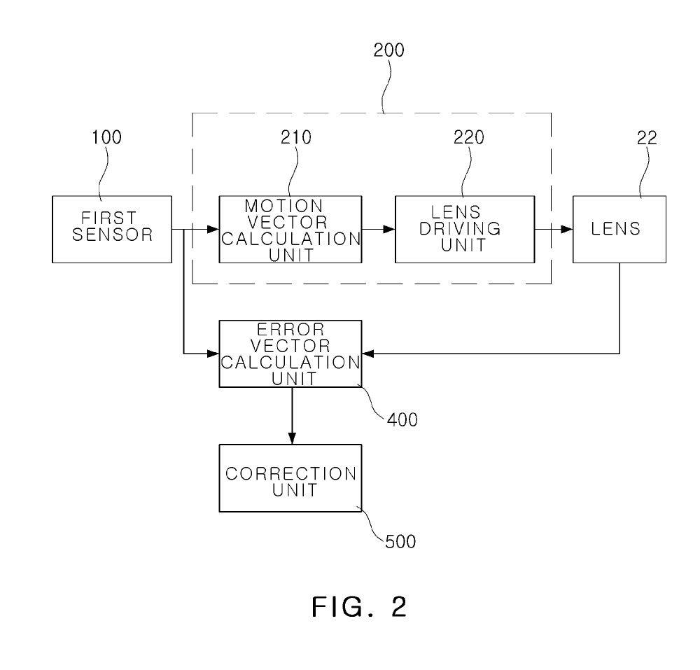

The configuration of the lens control unit 200 will be described in detail with respect to FIG. 2.

The second sensor 300 may sense the position of the lens 22 of the camera module 20. In an exemplary embodiment, the second sensor 300 may be a hall sensor. The second sensor 300 may sense the location of the lens 22 and may output it to the error vector calculation unit 400.

The error vector calculation unit 400 may calculate an error vector based on the movement value of the camera module 20 sensed by the first sensor 100 and the position value of the lens 22 sensed by the second sensor 300. In an exemplary embodiment, the error vector calculation unit 400 may compare the pitch values and yaw values sensed by the first sensor 100 with an x-coordinate value and a y-coordinate value sensed by the second sensor 300 so as to calculate an error vector. In an exemplary embodiment, the error vector calculation unit 400 may only be operated while a shutter (not shown) of the camera module 20 is open.

The correction unit 500 may correct an image generated by the image generation unit 24 in the camera module 20 based on the error vector calculated by the error vector calculation unit 400.

In an exemplary embodiment, the correction unit 500 may perform deconvolution on the error vector and an image generated by the image generation unit 24 using an image restoration filter, so as to correct image blur.

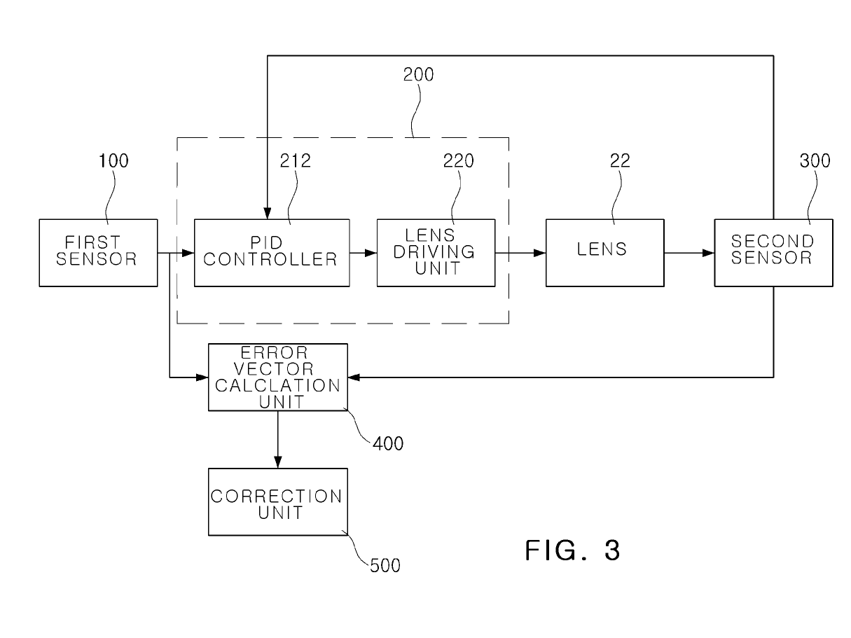

FIG. 2 is a block diagram of the lens control unit shown in FIG. 1 according to an exemplary embodiment of the present disclosure, and FIG. 3 is block diagram of the lens control unit shown in FIG. 1 according to another exemplary embodiment of the present disclosure.

Referring to FIG. 2, the lens control unit 200 according to an exemplary embodiment of the present disclosure may include a motion vector calculation unit 210 and a lens driving unit 220.

The motion vector calculation unit 210 may calculate a motion vector of the lens 22 in accordance with the movement of the camera module 20 sensed by the first sensor 100. That is, in order to prevent motion blur occurring due to the shaking of the camera module 20, the motion vector calculation unit 210 may generate a motion vector that includes values corresponding to the amount of movement in the direction opposite to that of the movement of the camera module 20.

In an exemplary embodiment, the motion vector calculation unit 210 may be a PID controller that receives a feedback signal indicating the position of the lens 22 from the second sensor 300 so as to calculate a motion vector, as shown in FIG. 3.

The lens driving unit 220 may adjust the position of the lens 22 based on the motion vector calculated by the motion vector calculation unit 210. The lens driving unit 220 may adjust the position of the lens 22 in a PWM manner or in a linear manner.

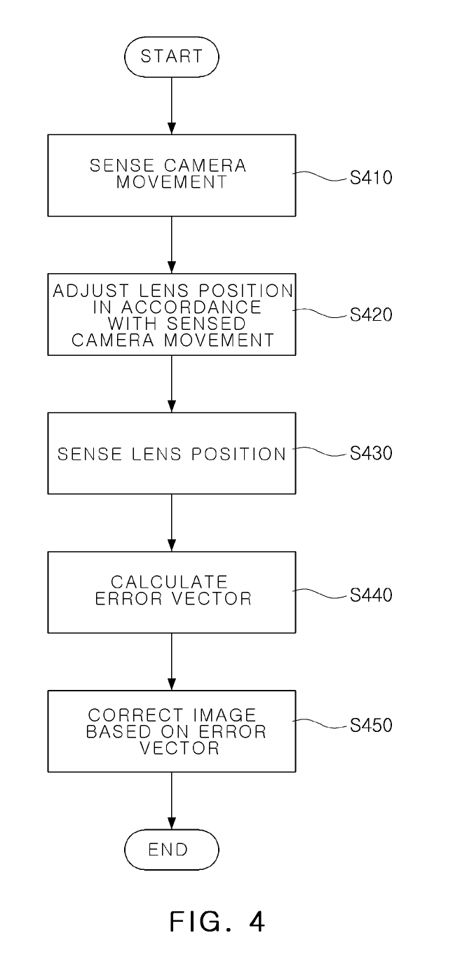

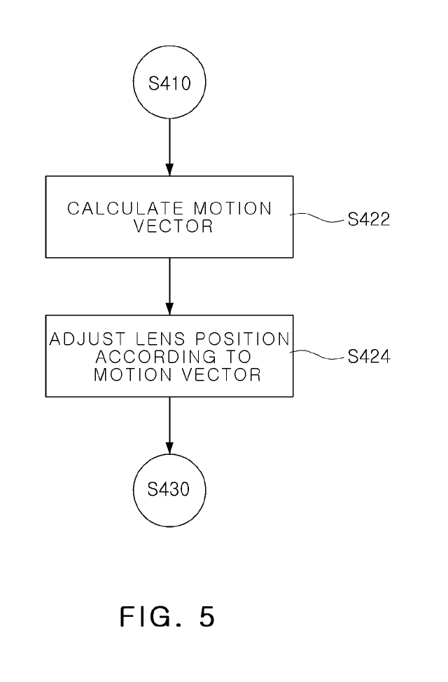

FIG. 4 is a flowchart for illustrating a method for image correction according to an exemplary embodiment of the present disclosure, and FIG. 5 is a flowchart for illustrating adjusting of the position of a lens of the method illustrated in FIG. 4 according to an exemplary embodiment of the present disclosure.

The method for image correction illustrated in FIG. 4 according to the exemplary embodiment is performed by the apparatus 10 for image correction described above with reference to FIGS. 1 through 3, and thus redundant descriptions will not be made.

Referring to FIG. 4, the apparatus 10 for image correction may sense movement of the camera module (S410). Then, the apparatus 10 for image correction may adjust the position of the lens 22 in accordance with the sensed movement of the camera module 20.

Then, the apparatus 10 for image correction may sense the position of the lens 22 (S430) and may calculate an error vector based on the sensed movement value of the camera module 20 and the position value of the lens 22 (S440).

Then, the apparatus 10 for image correction may correct an image captured by the camera module 20 based on the calculated error vector (S450).

In an exemplary embodiment, as shown in FIG. 5, the adjusting of the position of the lens S420 may include calculating a motion vector of the lens 22 corresponding to the sensed movement of the camera module 20 (S422), and adjusting the position of the lens 22 according to the calculated motion vector of the lens 22 (S424).

In an exemplary embodiment, the operations S410 to S440 may be performed only while a shutter of the camera module 20 is open and may be repeatedly performed a predetermined number of times depending on the time period in which the shutter of the camera module 20 is open.

As set forth above, according to an exemplary embodiment of the present disclosure, an error vector is calculated based on movement of a camera module sensed by a first sensor and a position of a lens sensed by a second sensor, and an image is corrected based thereon, so that a clearer image may be obtained.

While exemplary embodiments have been shown and described above, it will be apparent to those skilled in the art that modifications and variations could be made without departing from the spirit and scope of the present disclosure as defined by the appended claims.

What is claimed is:

1. An apparatus for image correction, comprising:
a first sensor configured to sense a movement of a camera module;
a lens control unit configured to adjust a position of a lens in the camera module in accordance with the movement of the camera module sensed by the first sensor;
a second sensor configured to sense the position of the lens;
an error vector calculation unit configured to calculate an error vector based on the movement of the camera module sensed by the first sensor and the position of the lens sensed by the second sensor; and
a correction unit configured to correct an image from the camera module based on the error vector.

2. The apparatus of claim 1, wherein the lens control unit adjusts the position of the lens in a direction opposite to that of the movement of the camera module sensed by the first sensor.

3. The apparatus of claim 1, wherein the first sensor senses angular velocity of the camera module, and the lens control unit calculates a motion vector of the lens corresponding to the angular velocity of the camera module sensed by the first sensor and adjusts the position of the lens according to the calculated motion vector of the lens.

4. The apparatus of claim 3, wherein the error vector calculation unit compares a value of angular velocity sensed by the first sensor with a value of a position of the lens sensed by the second sensor so as to calculate an error vector.

5. The apparatus of claim 3, wherein the motion vector is calculated by integrating values of angular velocity sensed by the first sensor.

6. The apparatus of claim 1, wherein the lens control unit includes:
a motion vector calculation unit configured to calculate a motion vector of the lens corresponding to the movement of the camera module sensed by the first sensor; and
a lens driving unit configured to adjust the position of the lens based on the calculated motion vector of the lens.

7. The apparatus of claim 6, wherein the motion vector calculation unit is a PID controller configured to receive a feedback signal indicating the position of the lens from the second sensor to calculate the motion vector.

8. The apparatus of claim 1, wherein the error vector calculation unit is only operated while a shutter of the camera module is open.

9. The apparatus of claim 1, wherein the first sensor is a gyro sensor configured to detect angular velocity of the camera module.

10. The apparatus of claim 1, wherein the second sensor is a hall sensor configured to detect the position of the lens.

11. An apparatus for image correction, comprising:
a gyro sensor configured to sense an angular velocity of a camera module;
a lens control unit configured to calculate a motion vector corresponding to the sensed angular velocity and adjusting a position of a lens of the camera module based on the motion vector;
a hall sensor configured to sense the position of the lens;
an error vector calculation unit configured to compare a value of angular velocity of the camera module sensed by the gyro sensor with a value of the position of the lens sensed by the hall sensor so as to calculate an error vector; and
a correction unit configured to correct an image captured by the lens based on the error vector,
wherein the lens control unit and the error vector calculation unit are only operated while a shutter of the camera module is open.

12. The apparatus of claim 11, wherein the lens control unit calculates a motion vector of the lens corresponding to angular velocity of a camera module sensed by the gyro sensor and adjusts the position of the lens based on the calculated motion vector of the lens.

13. The apparatus of claim 12, wherein the motion vector is calculated by integrating values of angular velocity sensed by the gyro sensor.

14. The apparatus of claim 11, wherein the lens control unit includes:
a motion vector calculation unit configured to calculate a motion vector of the lens corresponding to the angular velocity of the camera module sensed by the gyro sensor; and
a lens driving unit configured to adjust the position of the lens based on the calculated motion vector of the lens.

15. The apparatus of claim 14, wherein the motion vector calculation unit is a PID controller configured to receive a feedback signal indicating the position of the lens from the hall sensor to calculate the motion vector.

16. A method for image correction, comprising:
a) sensing movement of a camera module;
b) adjusting a position of a lens in the camera module in accordance with the sensed movement of the camera module;
c) sensing the position of the lens;
d) calculating an error vector based on the sensed movement of the camera module and the sensed position of the lens; and
e) correcting an image from the camera module based on the error vector.

17. The method of claim 16, wherein the operation a) of adjusting of the position of the lens includes calculating a motion vector of the lens corresponding to the sensed movement of the camera module; and adjusting the position of the lens based on the calculated motion vector of the lens.

18. The method of claim 16, wherein the operations a) to d) are repeatedly performed a predetermined number of times depending on the time period in which the shutter of the camera module is open.
